(19) United States
(12) Patent Application Publication
(10) Pub. No.: US 2018/0085825 A1
(43) Pub. Date: Mar. 29, 2018

(54) FLUID MATERIAL EJECTING APPARATUS

(71) Applicant: Seiko Epson Corporation, Tokyo (JP)

(72) Inventors: Masaya ISHIDA, Hara-mura (JP); Takeshi MIYASHITA, Suwa (JP); Eiji OKAMOTO, Matsumoto (JP); Akihiko TSUNOYA, Okaya (JP); Naoko SHIMA, Shiojiri (JP)

(21) Appl. No.: 15/700,554

(22) Filed: Sep. 11, 2017

(30) Foreign Application Priority Data
Sep. 26, 2016 (JP) 2016-187136

(51) Int. Cl. B22F 3/00; B28B 13/00; B33Y 30/00; B28B 1/00

(52) U.S. Cl. CPC B22F 3/008; B28B 1/001; B33Y 30/00; B28B 13/00

(57) ABSTRACT

A fluid material ejecting apparatus includes a material chamber to which a fluid material containing at least one of metal particles and ceramic particles is supplied, a valve seat constituting a part of the material chamber and including an ejection port, a piston movable in the material chamber in directions toward and away from the ejection port, and a driver of the piston. The driver is configured to cause the piston to contact the valve seat from a position away from the valve seat and move in the direction toward the ejection port so as to slide along the valve seat, to thereby eject the fluid material through the ejection port. Sliding surfaces of the piston and the valve seat via which the piston and the valve seat contact each other have a higher Vickers hardness than the particles contained in the fluid material.

### BACKGROUND

### 1. Technical Field

The present invention relates to a fluid material ejecting apparatus.

### 2. Related Art

Fluid material ejecting apparatuses are known that are configured to supply a fluid material to a material chamber and drive (move) a piston in the material chamber, to thereby eject the fluid material through an ejection port of the material chamber.

For example, WO2008/108097 discloses a liquid droplet ejecting apparatus (fluid material ejecting apparatus) configured to supply a liquid to a liquid chamber and drive a piston in the liquid chamber, to thereby eject the liquid through an ejection port of the liquid chamber.

Recently, users of the fluid material ejecting apparatus have come to require the apparatus to eject various types of fluid materials. For example, the fluid material ejecting apparatus may be utilized to form a three-dimensional (hereinafter, 3D) modeled object, in which case a metal or ceramic material may be employed as the material of the 3D modeled object. When the fluid material contains particles that constitute the 3D modeled object, it is sometimes difficult to stably eject the fluid material. In particular, when the particles are metal particles or ceramic particles, which have a high Vickers hardness, the piston may wear in the liquid chamber owing to continuous use of the fluid material ejecting apparatus, making it difficult to stably eject the fluid material over a long period of time.

### SUMMARY

An advantage of some aspects of the invention is to allow a fluid material containing particles having a high Vickers hardness, such as metal particles and ceramic particles, to be stably ejected over a long period of time.

In an aspect of the invention, provided is a fluid material ejecting apparatus including a material chamber to which a fluid material containing at least one of metal particles and ceramic particles is supplied, a valve seat constituting a part of the material chamber and including an ejection port, a piston movable in the material chamber in directions toward and away from the ejection port, and a driver of the piston. The driver is configured to cause the piston to contact the valve seat from a position away from the valve seat and move in the direction toward the ejection port so as to slide along the valve seat, to thereby eject the fluid material through the ejection port. Sliding surfaces of the piston and the valve seat via which the piston and the valve seat contact each other are higher in Vickers hardness than the particles contained in the fluid material.

With the foregoing configuration, the piston is driven so as to slide along the valve seat, instead of simply being driven (made to move) in the direction toward the ejection port in the material chamber. Therefore, the driving force of the piston can be efficiently transmitted to the fluid material in the material chamber, so that the fluid material can be stably ejected. Although with such a configuration the sliding surfaces are prone to wear because of the particles contained in the fluid material, employing a material higher in Vickers hardness than the particles contained in the fluid material to form the sliding surfaces prevents the wear and allows the fluid material to be stably ejected over a long period of time. Thus, even a fluid material containing particles having a high Vickers hardness, such as metal particles or ceramic particles, can be stably ejected over a long period of time.

In the fluid material ejecting apparatus configured as above, each of the sliding surfaces is formed of diamond-like carbon.

With the foregoing configuration, since each of the sliding surfaces is formed of diamond-like carbon which has a particularly high Vickers hardness, a fluid material containing particles having a high Vickers hardness, such as metal particles or ceramic particles, can be ejected with further improved stability, over a long period of time.

In the fluid material ejecting apparatus configured as above, each of the sliding surfaces is formed of a diamond-like carbon layer having a thickness equal to or thicker than 200 nm.

Forming the diamond-like carbon layer in a thickness equal to or thicker than 200 nm prevents generation of a pin hole. In more detail, forming the diamond-like carbon layer in a thickness equal to or thicker than 200 nm prevents the diamond-like carbon layer from being separated at the position where the pin hole is formed. Therefore, a fluid material containing particles having a high Vickers hardness, such as metal particles or ceramic particles, can be ejected with further improved stability, over a long period of time.

In the fluid material ejecting apparatus configured as above, at least a part of components constituting a flow path of the fluid material is higher in Vickers hardness than the particles contained in the fluid material.

With the foregoing configuration, not only the sliding surfaces but also one or more components constituting the flow path of the fluid material, which are made to contact the fluid material, are higher in Vickers hardness than the particles contained in the fluid material. Therefore, not only the sliding surfaces but also such components can be prevented from wearing.

In the fluid material ejecting apparatus configured as above, each of the sliding surfaces is higher in Vickers hardness by equal to or more than 500, than particles having a highest hardness among the particles contained in the fluid material.

With the foregoing configuration, since each of the sliding surfaces is higher in Vickers hardness by equal to or more than 500, which is a sufficiently large difference, than the particles having a highest hardness among the particles contained in the fluid material. Therefore, a fluid material containing particles having a high Vickers hardness, such as metal particles or ceramic particles, can be ejected with further improved stability, over a long period of time.

In another aspect of the invention, provided is a fluid material ejecting apparatus including a material chamber to which a fluid material containing particles is supplied, a valve seat constituting a part of the material chamber and including an ejection port, a piston movable in the material chamber in directions toward and away from the ejection port, and a driver of the piston. The driver is configured to cause the piston to contact the valve seat from a position away from the valve seat and move in the direction toward the ejection port so as to slide along the valve seat, to thereby eject the fluid material through the ejection port. Sliding surfaces of the piston and the valve seat via which the piston and the valve seat contact each other are formed of diamond-like carbon.

In the foregoing fluid material ejecting apparatus, each of the sliding surfaces is formed of diamond-like carbon. Since the diamond-like carbon has a particularly high Vickers hardness, the sliding surfaces may generally be assumed to be higher in Vickers hardness than the particles contained in the fluid material, even if the material of the particles is unidentified. Therefore, the fluid material can be stably ejected over a long period of time, even when the user is unaware of the type of the particles contained in the fluid material.

### BRIEF DESCRIPTION OF THE DRAWINGS

The invention will be described with reference to the accompanying drawings, wherein like numbers reference like elements.

FIG. 1 is a schematic side view of a fluid material ejecting apparatus according to a first embodiment of the invention.

FIG. 2 is a block diagram showing a configuration of the fluid material ejecting apparatus according to the first embodiment of the invention.

FIG. 3 is a fragmentary cross-sectional view illustrating the essential part of the fluid material ejecting apparatus according to the first embodiment of the invention.

FIG. 4 is a fragmentary cross-sectional view illustrating the essential part of the fluid material ejecting apparatus according to the first embodiment of the invention.

FIG. 5 is a fragmentary cross-sectional view illustrating the essential part of the fluid material ejecting apparatus according to the first embodiment of the invention.

FIG. 6 is a schematic side view of a fluid material ejecting apparatus according to a second embodiment of the invention.

### DESCRIPTION OF EXEMPLARY EMBODIMENTS

Hereafter, the invention will be described in detail with reference to the drawings.

### First Embodiment

First, a fluid material ejecting apparatus (manufacturing apparatus of a 3D modeled object) according to a first embodiment of the invention will be described.

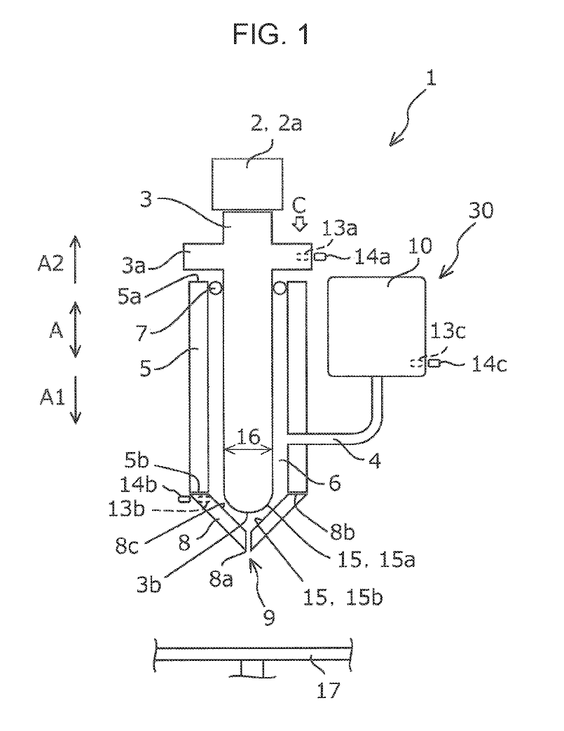

FIG. 1 is a schematic side view of a fluid material ejecting apparatus 1 according to this embodiment.

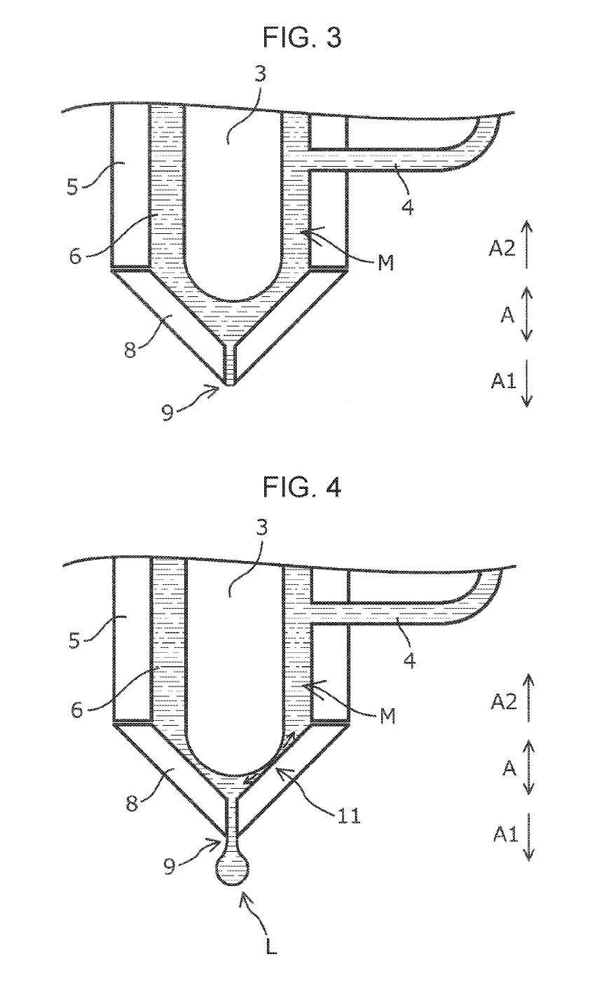

Although the fluid material ejecting apparatus 1 is exemplified by the manufacturing apparatus of the 3D modeled object in this embodiment, the fluid material ejecting apparatus 1 may be a different apparatus provided that the apparatus is configured to eject a fluid material M (see FIG. 3 to FIG. 5). For example, the fluid material ejecting apparatus 1 may be an ink jet recording apparatus that records an image on a sheet-shaped recording medium.

The fluid material ejecting apparatus 1 according to this embodiment includes a cylindrical main portion 5 connected via a tube 4 to a cartridge 10a in which the fluid material M for forming the 3D modeled object is stored, a piston 3 inserted in the main portion 5 from the side of an end portion 5a, and a valve seat 8 connected to the other end portion 5b of the main portion 5.

The valve seat 8 has a conical shape in which a conical space is formed, and includes an ejection port 9 formed at a tip portion 8a of the valve seat 8 so as to communicate with the inner space. An end portion 8b of the valve seat 8 on the bottom side of the conical shape is connected to the end portion 5b of the main portion 5. The inner space is defined by forming a sloped surface 8c inside the valve seat 8.

The fluid material ejecting apparatus 1 according to this embodiment also includes a piezoelectric element 2a configured to move the piston 3 inside the main portion 5 in a direction A, which is the longitudinal direction of the cylinder, so as to serve as a driver 2 of the piston 3.

The piston 3 includes a protruding portion 3a, and is set such that an elongate portion extending from the protruding portion 3a (on the side of a tip portion 3b) is inserted in the main portion 5, and a shorter portion on the opposite side of the tip portion 3b with respect to the protruding portion 3a is connected to the piezoelectric element 2a.

The piston 3 thus set at a predetermined position is pressed in a direction C (direction A1 toward the ejection port 9, in the direction A) when a voltage is applied to the piezoelectric element 2a and the piezoelectric element 2a is deformed. When the voltage to the piezoelectric element 2a is disconnected, the piezoelectric element 2a recovers the original shape and returns to the original position shown in FIG. 1, in other words moves in a direction A2 opposite to the direction A1, in the direction A.

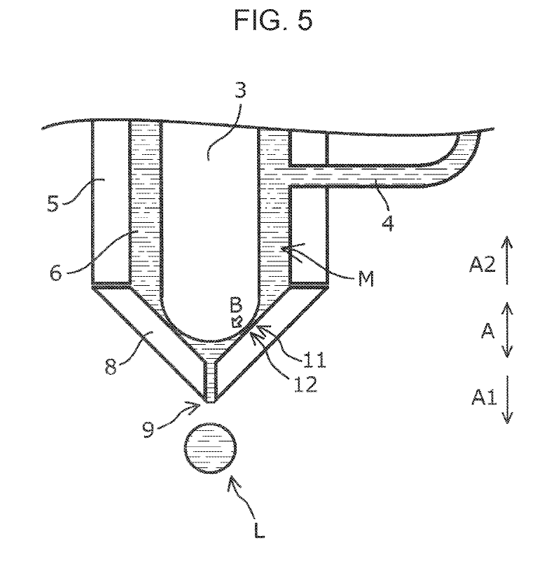

An O-ring 7 is fitted between the main portion 5 and the piston 3, to serve as a seal member. Accordingly, a material chamber 6, in which the fluid material M supplied from the cartridge 10 is introduced, is formed in the space between the piston 3 and the inner wall of the main portion and the valve seat 8. The fluid material ejecting apparatus 1 according to this embodiment drives the piston 3 (makes the piston 3 reciprocate in the directions A1 and A2) when the fluid material M is introduced in the material chamber 6, to thereby eject a liquid droplet L (see FIG. 4 and FIG. 5) through the ejection port 9, further details of which will be subsequently described. To eject the liquid droplet L of the fluid material M through the ejection port 9, the piston 3 is not simply moved toward the ejection port 9 but also made to slide along the valve seat 8 via sliding surfaces 15 (a sliding surface 15a of the piston 3 and a sliding surface 15b of the valve seat 8).

The fluid material ejecting apparatus 1 according to this embodiment also includes a stage 17 located so as to oppose the ejection port 9, to receive the liquid droplet L of the fluid material M ejected through the ejection port 9. The stage 17 is movable in a direction intersecting (orthogonal to) the direction A, and also in the direction A. Accordingly, a desired 3D modeled object can be formed on the stage 17, by moving the stage 17 while ejecting the liquid droplet L of the fluid material M through the ejection port 9.

Further, the cartridge 10, the piston 3 and the valve seat 8 of the fluid material ejecting apparatus 1 according to this embodiment are detachable, so that a plurality of cartridges 10 to be each used for a different fluid material M, a plurality of pistons 3 and a plurality of valve seats 8 of different structures can be employed. In addition, the cartridge 10 includes a chip 13c serving as a material information provision unit for the corresponding fluid material M, and the piston 3 and the valve seat 8 respectively include a chip 13a and 13b each serving as a structure information provision unit for the corresponding structure.

Hereunder, an electrical configuration of the fluid material ejecting apparatus 1 according to this embodiment will be described.

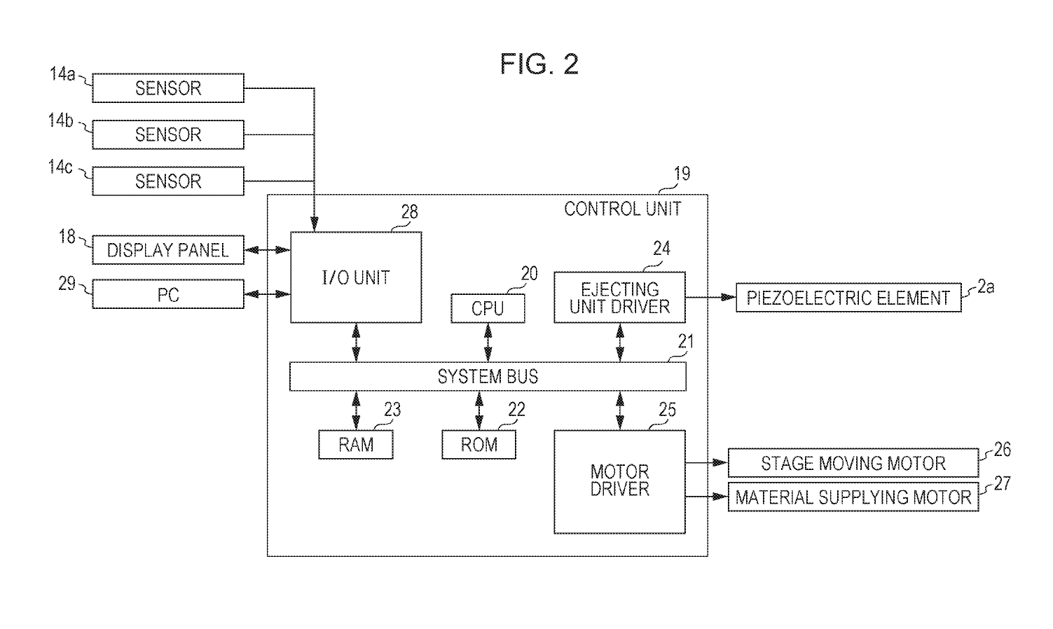

FIG. 2 is a block diagram showing a configuration of the fluid material ejecting apparatus 1 according to this embodiment.

A control unit 19 includes a CPU 20 that controls an overall operation of the fluid material ejecting apparatus 1. The CPU 20 is connected via a system bus 21 to a ROM 22 containing operation programs to be executed by the CPU 20 and a RAM 23 for temporarily storing data.

The CPU 20 is also connected via the system bus 21 to an ejecting unit driver 24 that drives the piezoelectric element 2a.

The CPU 20 is also connected to a motor driver 25 via the system bus 21. The motor driver 25 is connected to a stage moving motor 26 for moving the stage 17, and a material supplying motor 27 for supplying the fluid material M from the cartridge 10 to the material chamber 6.

Further, the CPU 20 is connected to an input/output (I/O) unit 28 via the system bus 21. The I/O unit 28 is connected to sensors 14a, 14b, and 14c serving as information reading units for reading the information from the chips 13a, 13b, and 13c, a display panel 18 for notifying (displaying) the information read by the sensors 14a, 14b, and 14c to the user, and a PC 29 including a non-illustrated monitor and used for transmission and reception of data and signals.

With the foregoing configuration, the control unit 19 makes an overall control of the fluid material ejecting apparatus 1.

As described above, the fluid material ejecting apparatus 1 according to this embodiment includes a setting base 30 for setting the cartridge 10 containing the fluid material M, the material chamber 6 to which the fluid material M is supplied, the valve seat 8 constituting a part of the material chamber 6 and including the ejection port, the piston 3 movable inside the material chamber 6 in the direction A1 toward the ejection port 9 and the direction A2 away from the ejection port 9, and the driver 2 of the piston 3. A plurality of cartridges 10, each of which is detachable and prepared to store different types of fluid materials M, can be employed. In addition, at least one of the valve seat 8 and the piston 3 (in this embodiment, both) is detachable, and a plurality of detachable components different in structure can be employed. Further, the cartridges 10 each include the chip 13c for the corresponding fluid material M, and the detachable components (valve seat 8 and piston 3) each include the chip 13a and 13b for the corresponding structure. The fluid material ejecting apparatus 1 also includes the sensors 14a, 14b, and 14c that respectively read the information from the chips 13a, 13b, and 13c.

Thus, in the fluid material ejecting apparatus 1 according to this embodiment, at least one of the valve seat 8, constituting a part of the material chamber 6 and including the ejection port 9, and the piston 3 is the detachable component. In addition, the sensors 14a, 14b, and 14c are provided to read the information regarding the fluid material M and the detachable component. Such a configuration enables setting of driving conditions of the piston 3, and notification of the proper selection of the valve seat 8 and the piston 3 (display whether the proper valve seat 8 and piston 3 are attached, on the display panel 18 and the monitor of the PC 29) to the user, according to the information read by the sensors 14a, 14b, and 14c. Therefore, the fluid material ejecting apparatus 1 according to this embodiment is configured to properly eject the fluid material M according to the type thereof.

In this embodiment, each of the chips 13a and 13b corresponds to the structure information provision unit, the chip 13c corresponds to the material information provision unit, and each of the sensors 14a, 14b, and 14c corresponds to the information reading unit. However, a different configuration may be adopted. For example, the information may be expressed in characters so as to serve as the structure information provision unit and the material information provision unit, and a reading mechanism for reading the characters may be provided, as the information reading unit.

In particular, since the valve seat 8 and the piston 3 of the fluid material ejecting apparatus 1 according to this embodiment are both detachable components, both of the valve seat 8 and the piston 3 can be replaced with the appropriate ones. Such a configuration improves the properness of the ejecting operation of the fluid material M, according to the type thereof.

In addition, as described above, the fluid material ejecting apparatus 1 according to this embodiment includes the control unit 19 configured to control the driving action of the driver 2 according to the reading results of the sensors 14a, 14b, and 14c. Therefore, the driving condition of the piston 3 can be automatically and simply set, in the fluid material ejecting apparatus 1 according to this embodiment.

Here, the expression “control the driving action of the driver 2 according to the reading results of the sensors 14a, 14b, and 14c” refers to, for example, notifying a decision made by the control unit 19 to the user or stopping the operation of the piston 3, when the control unit 19 decides that an inappropriate type of the valve seat 8 or piston 3 is attached.

Table cited hereunder show decision examples on whether the appropriate valve seat 8 and piston 3 are attached. In the fluid material ejecting apparatus 1 according to this embodiment, the valve seat 8 and the piston 3 having the sliding surface 15 (sliding surface 15a of the piston 3 and sliding surface 15b of the valve seat 8) formed of tungsten carbide (WC: Vickers hardness approximately 1700 to 2050) or diamond-like carbon (DLC: Vickers hardness approximately 7000 to 15300) can be employed. Regarding the fluid material M, a material containing copper (Cu: Vickers hardness up to approximately 400) particles, stainless steel (SUS: Vickers hardness approximately 200 to 400) particles, silicon dioxide (SiO₂: Vickers hardness approximately 1100) particles, or alumina (Al₂O₃: Vickers hardness approximately 2300) particles may be employed. Accordingly, the control unit 19 causes the display panel 18 and the monitor of the PC 29 to display “OK” when the appropriate valve seat 8 and piston 3 are attached, and “NG” when either or both of the valve seat 8 and the piston 3 are inappropriate.

TABLE

Fluid Material

| Valve Seat | Piston | Cu | SUS | SiO₂ | Al₂O₃ |
|---|---|---|---|---|---|
| WC | WC | OK | OK | NG | NG |
| WC | DLC | NG | NG | NG | NG |
| DLC | WC | NG | NG | NG | NG |
| DLC | DLC | OK | OK | OK | OK |

In addition, as described above, the fluid material ejecting apparatus 1 according to this embodiment includes the display panel 18 serving as a notification unit that displays the detail of the control performed by the control unit 19. Therefore, the fluid material ejecting apparatus 1 according to this embodiment is capable of notifying the detail of the control performed by the control unit 19 to the user, such as the decision according to the examples in Table, and the driving condition of the piston 3 applied when the appropriate valve seat 8 and piston 3 are attached.

Here, the term “detail of control” refers to, for example, the driving condition of the piston 3, information related to the type of the fluid material M (e.g., properties, type of particles contained), information related to the structures of the piston 3 and the valve seat (e.g., piston diameter 16, sizes, shapes such as the angle of the sloped surface 8c, and materials), and the decision result made when the control unit 19 decides that the attached valve seat 8 and piston 3 are inappropriate.

Further, in the fluid material ejecting apparatus 1 according to this embodiment, the driver 2 makes the piston 3 contact the valve seat 8 from a position away therefrom, and further move the piston 3 in the direction A1 toward the ejection port 9 in sliding contact with the valve seat 8, to thereby eject the fluid material M through the ejection port 9. In the case where the fluid material M contains particles, the control unit 19 can permit the piston 3 to move when the respective sliding surfaces 15 via which the piston 3 and the valve seat 8 contact each other are higher in Vickers hardness than the particles (OK in Table), but restrict the piston 3 from moving when the sliding surfaces 15 are lower in Vickers hardness (NG in Table).

Moving the piston 3 in sliding contact with the valve seat 8 instead of simply moving the piston 3 in the material chamber 6 (in the direction A1 toward the ejection port 9) allows the driving force of the piston 3 to be effectively transmitted to the fluid material M in the material chamber 6 and enables stable ejection. With such a configuration, in the case where the fluid material M contains particles, the sliding surfaces 15 are prone to wear because of the particles contained in the fluid material. However, the fluid material ejecting apparatus 1 according to this embodiment is configured to permit the piston 3 to move when the respective sliding surfaces 15 via which the piston 3 and the valve seat 8 contact each other are higher in Vickers hardness than the particles, but to restrict the piston 3 from moving when the sliding surfaces are lower in Vickers hardness. Such an arrangement prevents the wear of the sliding surfaces 15 thereby enabling the fluid material M to be stably ejected over a long period of time.

The operation of the piston 3 performed in the material chamber 6 to eject the fluid material M will now be described in detail hereunder.

FIG. 3 to FIG. 5 are schematic drawings each showing an essential part of the fluid material ejecting apparatus 1, and illustrate the material chamber 6 in which the fluid material M is introduced (loaded). FIG. 3 illustrates a state where the piston 3 is located away from the valve seat 8 (same position as in FIG. 1). FIG. 4 illustrates a state where the piston 3 has been moved from the position shown in FIG. 3 in the direction A1 toward the ejection port 9 until the piston 3 makes contact with a slide start position 11 on the valve seat 8. Here, the term “contact” includes a state where the piston 3 is only a minute distance away from the valve seat 8 (e.g., in contact with the valve seat 8 via the particles contained in the fluid material M).

FIG. 5 illustrates a state where the piston 3 has been further moved and slid from the position shown in FIG. 4 in the direction A1 toward the ejection port 9 until the piston 3 reaches a slide end position 12 on the valve seat 8.

The fluid material ejecting apparatus 1 according to this embodiment is configured to cause the driver 2 to move the piston 3 from a position away from the valve seat 8 (FIG. 3) so as to contact the slide start position 11 on the valve seat 8 (FIG. 4), and then to the slide end position 12 on the valve seat 8 (FIG. 5), to thereby eject the liquid droplet L of the fluid material M. The fluid material ejecting apparatus 1 then returns the piston 3 to the position away from the valve seat 8 (FIG. 3) and repeats the position transition (moving of the piston 3) from the state shown in FIG. 3 to the state shown in FIG. 5, to thereby successively eject the liquid droplet L of the fluid material M.

In more detail, when the piston 3 comes to the position shown in FIG. 4 from the position shown in FIG. 3, the slide start position 11 serves as a watershed upon being contacted by the piston 3, so that the fluid material M is squeezed to both sides of the slide start position 11. Then the liquid droplet L is formed at the ejection port 9 owing to the force by which the fluid material M is squeezed. Here, the term “slide” includes a state where the piston 3 moves with only a minute distance from the valve seat 8 (e.g., sliding along the valve seat 8 in a sliding direction B via the particles contained in the fluid material M).

When the piston 3 reaches the position shown in FIG. 5 from the position shown in FIG. 4, the fluid material M is further squeezed because the piston 3 is made to slide in the sliding direction B from the slide start position 11 to the slide end position 12, so that the liquid droplet L formed at the ejection port 9 is separated therefrom and ejected in the direction A1.

Here, the fluid material ejecting apparatus 1 according to this embodiment is also configured to move the stage 17 in the direction intersecting the direction A, in addition to successively ejecting the liquid droplet L through the ejection port 9 as above, to thereby form a first layer of the 3D modeled object, which is formed of multiple layers, on the stage 17. Upon forming the first layer of the 3D modeled object, the fluid material ejecting apparatus 1 moves the stage 17 in the direction A1 by a distance corresponding to the thickness of the first layer of the 3D modeled object, and forms a second layer of the 3D modeled object over the first layer thereof. Such actions are repeated to form a third layer, a fourth layer, and so forth, of the layered structure of the desired 3D modeled object, so that the desired 3D modeled object is obtained.

As described above, the fluid material ejecting apparatus 1 according to this embodiment includes the material chamber 6 in which the fluid material M containing at least one of the metal particles and the ceramic particles is introduced, the valve seat 8 constituting a part of the material chamber 6 and including the ejection port 9, the piston 3 movable in the material chamber 6 in the direction A1 toward the ejection port 9 and the direction A2 away from the ejection port 9, and the driver 2 of the piston 3.

With the mentioned configuration, the fluid material ejecting apparatus 1 causes the driver 2 to move the piston 3, as shown in FIG. 3 to FIG. 5, from the position away from the valve seat 8 (FIG. 3) in the direction A1 toward the ejection port 9 so as to contact the valve seat 8 (FIG. 4), and then to make the piston 3 slide along valve seat 8 (FIG. 5), to thereby eject the fluid material M through the ejection port 9.

In addition, adopting a combination of the fluid material M, the piston 3, and the valve seat 8 among the combinations indicated as OK in Table allows the sliding surfaces 15 via which the piston 3 and the valve seat 8 contact each other to have a higher Vickers hardness than that of the particles contained in the fluid material M.

The fluid material ejecting apparatus 1 according to this embodiment is configured to move the piston 3 in sliding contact with the valve seat 8 instead of simply moving the piston 3 in the material chamber 6 (in the direction A1 toward the ejection port 9), and hence the driving force of the piston 3 can be effectively transmitted to the fluid material M in the material chamber 6, so that the fluid material M can be stably ejected. With such a configuration, the sliding surfaces 15 are prone to wear because of the particles contained in the fluid material. However, employing a material higher in Vickers hardness than the particles contained in the fluid material M to form the sliding surfaces 15 prevents the wear and allows the fluid material M to be stably ejected over a long period of time. Thus, even the fluid material M containing the particles having a high Vickers hardness, such as the metal particles and ceramic particles, can be stably ejected over a long period of time. Further, preventing the wear of the sliding surfaces 15 also prevents the constituent material of the sliding surfaces 15 from being mixed in the fluid material M (prevents the fluid material M from being contaminated by impurities).

In this embodiment, the sliding surfaces 15a and 15b are both formed of diamond-like carbon. Since the sliding surfaces 15 are thus formed of the diamond-like carbon which has a particularly high Vickers hardness, the fluid material containing the particles having a high Vickers hardness, such as the metal particles or ceramic particles, can be ejected with further improved stability, over a long period of time.

Since the diamond-like carbon has a particularly high Vickers hardness, the sliding surfaces 15 may generally be assumed to be higher in Vickers hardness than the particles contained in the fluid material M, even if the material of the particles is unidentified. Therefore, the fluid material M can be stably ejected over a long period of time, even when the user is unaware of the type of the particles contained in the fluid material M.

More specifically, the sliding surfaces 15a and 15b according to this embodiment are both formed of a diamond-like carbon layer having a thickness equal to or thicker than 200 nm.

Forming the diamond-like carbon layer in a thickness equal to or thicker than 200 nm prevents generation of a pin hole. In more detail, in the fluid material ejecting apparatus 1 according to this embodiment the diamond-like carbon layer of the sliding surfaces 15 is formed in a thickness equal to or thicker than 200 nm, so that the diamond-like carbon layer can be prevented from being separated at the position where the pin hole is formed. Therefore, the fluid material ejecting apparatus 1 according to this embodiment is capable of ejecting the fluid material M containing the particles having a high Vickers hardness, such as the metal particles or ceramic particles, with further improved stability over a long period of time.

The composition of the diamond-like carbon is not specifically limited. For example, a diamond-like carbon free from hydrogen, or another diamond-like carbon containing a certain ratio of hydrogen may be employed. It is preferable, however, to employ a diamond-like carbon having a lower content of hydrogen. In addition, whereas the diamond-like carbon has an amorphous structure composed of a hybridized orbital of sp² orbital and sp³ orbital, it is preferable to employ a diamond-like carbon having a higher ratio of sp³ orbital, from the viewpoint of attaining a higher Vickers hardness.

Whereas the diamond-like carbon layer of the sliding surface 15 according to this embodiment has a layered structure, forming the layer such that an inner portion has a higher Vickers hardness than that of an outer portion effectively prevents the diamond-like carbon layer from being damaged or separated.

Further, employing the material higher in Vickers hardness than the particles contained in the fluid material M to form not only the sliding surfaces 15 but also the components constituting the flow path of the fluid material M, which hence contact with the fluid material M, prevents the wear of such components, in addition to the wear of the sliding surfaces 15.

Here, the term “components constituting the flow path of the fluid material M” refers to all the components supposed to make contact with the fluid material M, examples of which include the inner wall of the cartridge 10, the tube 4, the inner wall of the main portion 5, the entirety of the sloped surface 8c of the valve seat 8, and the ejection port 9 (including the entirety of a nozzle including the region from the sloped surface 8c to the ejection port 9).

Further, it is preferable to form the sliding surfaces 15 such that the Vickers hardness thereof becomes higher by 500 or more, than that of particles having a highest hardness among the particles contained in the fluid material M. This is because such a configuration allows the fluid material M containing the particles having a high Vickers hardness, such as the metal particles or ceramic particles, to be ejected with further improved stability over a long period of time.

Here, in the fluid material ejecting apparatus 1 according to this embodiment, the control unit 19 is configured to display as OK on the display panel 18 when, as indicated in Table cited above, the combination is adopted in which the piston 3 and the valve seat 8 have the Vickers hardness higher by 500 or more than that of particles having a highest hardness among the particles contained in the fluid material M.

### Second Embodiment

Hereunder, the fluid material ejecting apparatus 1 according to a second embodiment will be described in detail with reference to the drawings.

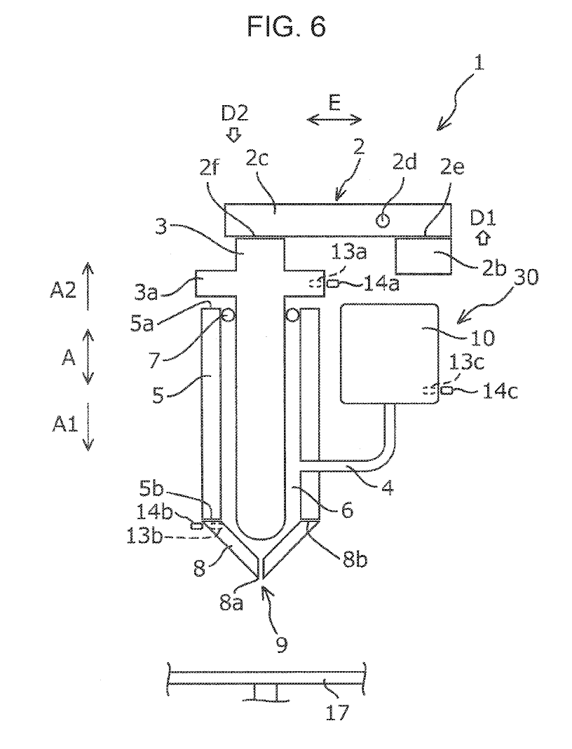

FIG. 6 is a schematic side view of the fluid material ejecting apparatus 1 according to the second embodiment, viewed in the same direction as FIG. 1 illustrating the fluid material ejecting apparatus 1 according to the first embodiment.

The fluid material ejecting apparatus 1 according to the second embodiment has the same configuration as that of the fluid material ejecting apparatus 1 according to the first embodiment, except for the structure of the driver 2, and the same components as those of the fluid material ejecting apparatus 1 according to the first embodiment are given the same numeral.

The driver 2 according to the first embodiment includes the piezoelectric element 2a, to deform the piezoelectric element 2a in the direction A1 so as to press the piston 3 in the direction A1, by applying a voltage to the piezoelectric element 2a.

In contrast, the driver 2 according to this embodiment includes a piezoelectric element 2b and a bar-shaped portion 2c. The bar-shaped portion 2c includes a rotary shaft 2d, and is located such that the lower face of an end portion 2e contacts the piezoelectric element 2b, and the lower face of the other end portion 2f on the opposite side with respect to the rotary shaft 2d contacts the piston 3. When a voltage is applied to the piezoelectric element 2b, the piezoelectric element 2b is deformed in a direction D1 (direction A2) so as to press the end portion 2e upward and thus press the piston 3 in a direction D2 (direction A1) according to the lever principle, such that the contact area between the end portion 2e and the piezoelectric element 2b acts as the point of application, the rotary shaft 2d acts as the fulcrum, and the contact area between the other end portion 2f and the piston 3 acts as the point of action.

Here, the driver 2 according to this embodiment (piezoelectric element 2b and bar-shaped portion 2c) is movable as a whole in a direction E with respect to the piston 3, so as to shift the contact area (contact position) of the other end portion 2f with the piston 3 thereby adjusting the force to press (distance to press) the piston in the direction D2. Therefore, the size of the liquid droplet L (amount of the fluid material M) ejected through the ejection port 9 can be effectively adjusted.

However, the configuration of the driver 2 is not limited to that of each of the first and second embodiments. For example, a spring and a compression mechanism therefor, or an air pressure control mechanism may be employed, instead of the piezoelectric element 2a or 2b.

The present invention is not limited to the foregoing embodiments, but may be modified in various manners within the scope of the present invention. For example, although the piston 3 is supposed to be pressed in the direction A1, the piston 3 may be pressed in a direction intersecting the direction A1 depending on the eccentricity or processing accuracy of the piston 3. In such a case also, the piston 3 can be prevented from wearing owing to contacts and sliding motion. In addition, the technical features described in the embodiments corresponding to those set forth in the section of Summary may be substituted or combined as desired, to attain a part or the whole of the advantages described above. Further, in the case any of the technical features is not herein defined as mandatory, such technical features may be excluded as desired.

The entire disclosure of Japanese Patent Application No. 2016-187136, filed Sep. 26, 2016 is expressly incorporated by reference herein.

What is claimed is:

1. A fluid material ejecting apparatus comprising:
a material chamber to which a fluid material containing at least one of metal particles and ceramic particles is supplied;
a valve seat constituting a part of the material chamber and including an ejection port;
a piston movable in the material chamber in directions toward and away from the ejection port; and
a driver of the piston,
wherein the driver is configured to cause the piston to contact the valve seat from a position away from the valve seat and move in the direction toward the ejection port so as to slide along the valve seat, to thereby eject the fluid material through the ejection port, and
wherein sliding surfaces of the piston and the valve seat via which the piston and the valve seat contact each other have a higher Vickers hardness than the particles contained in the fluid material.

2. The fluid material ejecting apparatus according to claim 1,
wherein each of the sliding surfaces is made of diamond-like carbon.

3. The fluid material ejecting apparatus according to claim 2,
wherein each of the sliding surfaces is formed of a diamond-like carbon layer having a thickness equal to or thicker than 200 nm.

4. The fluid material ejecting apparatus according to claim 1,
wherein at least a part of components constituting a flow path of the fluid material is higher in Vickers hardness than the particles contained in the fluid material.

5. The fluid material ejecting apparatus according to claim 1,
wherein each of the sliding surface is higher in Vickers hardness by equal to or more than 500, than particles having a highest hardness among the particles contained in the fluid material.

6. A fluid material ejecting apparatus comprising:
a material chamber to which a fluid material containing particles is supplied;
a valve seat constituting a part of the material chamber and including an ejection port;
a piston movable in the material chamber in directions toward and away from the ejection port; and
a driver of the piston,
wherein the driver is configured to cause the piston to contact the valve seat from a position away from the valve seat and move in the direction toward the ejection port so as to slide along the valve seat, to thereby eject the fluid material through the ejection port, and
wherein sliding surfaces of the piston and the valve seat via which the piston and the valve seat contact each other are formed of diamond-like carbon.
